(19) United States
(12) Patent Application Publication
(10) Pub. No.: US 2026/0046527 A1
(43) Pub. Date: Feb. 12, 2026

(54) FLICKER DETECTION AND CORRECTION FOR IMAGE FRAMES

(71) Applicant: QUALCOMM Incorporated, San Diego, CA (US)

(72) Inventors: Vamshi Krishna Reddy Anireddy, Karimnagar (IN); Soman Ganesh Nikhara, Hyderabad (IN); Yagnesh Badiyani, Hyderabad (IN)

(21) Appl. No.: 18/798,529

(22) Filed: Aug. 8, 2024

(51) Int. Cl. H04N 23/745; H04N 23/63; H04N 23/667; H04N 23/72; H04N 23/73; H04N 23/743

(52) U.S. Cl. CPC H04N 23/745; H04N 23/632; H04N 23/667; H04N 23/72; H04N 23/73; H04N 23/743

(57) ABSTRACT

A device for image processing includes one or more memories configured to store image data; and processing circuitry coupled to the one or more memories, wherein the processing circuitry is configured to: determine initial camera parameters including an initial exposure time for capturing images; perturb the initial exposure time to determine at least one of a first exposure time and a second exposure time; cause an image sensor to capture a first image of the image data at the first exposure time; cause the image sensor to capture a second image of the image data at the second exposure time; determine a characteristic of flicker based on at least the first image and the second image; and generate an output based on the determined characteristic of flicker.

### TECHNICAL FIELD

The disclosure relates to image processing including flicker correction for image frames.

### BACKGROUND

Flicker, sometimes referred to as banding, occurs in image frames due to periodicity of a light element. A light element connected to an alternating current source tends to dim and brighten at double the frequency as the frequency of the alternating current source.

Some image sensors use rolling shutter, where the image sensor exposes different portions of the sensor at different times (e.g., row-by-row or column-by-column). The periodic dimming and brightening of the light element results in different amounts of light being available at different times.

### SUMMARY

In general, this disclosure describes techniques for flicker correction, also called banding correction, of image frames. Flicker or banding refers to the luminance (e.g., brightness) of different flicker bands (e.g., portions) of an image frame being different. Flicker tends to occur due to the periodicity of luminance from a lighting source, such as due to the frequency of the power source that provides power to the lighting source.

There may be various characteristics of flicker. For instance, flicker may be measured based on a phase of the flicker and/or a strength of the flicker. The phase of the flicker may be indicative of locations where flicker bands will be located in images, and the strength of the flicker may be indicative of change of luminance of the flicker bands (e.g., the brightness of the flicker bands) in the images.

One type of flicker is referred to as static flicker. In static flicker, the flicker bands are located in same location in multiple images (e.g., two different images) captured at the same exposure time. That is, a location of the flicker bands in one image having flicker corresponds to a location of the flicker bands in another image. Another type of flicker is rolling flicker in which the location of these bands may change (e.g., roll) in multiple images captured at the same exposure time. In static and rolling flicker, there may be one band with lower luminance, followed by another band with higher luminance, followed by another band with lower luminance, and so forth. Other examples of bands exist.

Flicker can negatively impact viewer experience by artificially creating bands having different luminance in the image. This disclosure describes example techniques to detect and remove flicker, thereby increasing viewer experience.

In one or more examples, processing circuitry (e.g., of an image signal processor (ISP)) may be configured to perturb an exposure time at which images are captured, so as to cause an image sensor to capture multiple images with different exposure times. The exposure time refers to an amount of time an image sensor is exposed to light when capturing an image. The processing circuitry may be configured to determine a characteristic of the flicker (e.g., phase of a flicker or a strength of the flicker) based on at least on these images captured with different exposure times. Due to the images being captured with different exposure times, the characteristic of the flicker, such as the phase and strength of the flicker, may be different in the images, which creates sufficient difference in the images for flicker detection. The processing circuitry may determine a scaling factor (e.g., inverse flicker gain) based on the characteristic of flicker, and apply the scaling factor to compensate for the flicker.

In one example, the disclosure describes a device for image processing, the device comprising: one or more memories configured to store image data; and processing circuitry coupled to the one or more memories, wherein the processing circuitry is configured to: determine initial camera parameters including an initial exposure time for capturing images; perturb the initial exposure time to determine at least one of a first exposure time and a second exposure time; cause an image sensor to capture a first image of the image data at the first exposure time; cause the image sensor to capture a second image of the image data at the second exposure time; determine a characteristic of flicker based on at least the first image and the second image; and generate an output based on the determined characteristic of flicker.

In one example, the disclosure describes a method of image processing, the method comprising: determining initial camera parameters including an initial exposure time for capturing images; perturbing the initial exposure time to determine at least one of a first exposure time and a second exposure time; causing an image sensor to capture a first image of image data at the first exposure time; causing the image sensor to capture a second image of the image data at the second exposure time; determining a characteristic of flicker based on at least the first image and the second image; and generating an output based on the determined characteristic of flicker.

In one example, the disclosure describes one or more computer-readable storage media storing instructions thereon that when executed cause one or more processors to: determine initial camera parameters including an initial exposure time for capturing images; perturb the initial exposure time to determine at least one of a first exposure time and a second exposure time; cause an image sensor to capture a first image of image data at the first exposure time; cause the image sensor to capture a second image of the image data at the second exposure time; determine a characteristic of flicker based on at least the first image and the second image; and generate an output based on the determined characteristic of flicker.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram of a device configured to perform one or more of the example techniques described in this disclosure.

FIG. 2 is a graph illustrating an example of a characteristic of flicker at different exposure times.

FIG. 3 is a block diagram illustrating an image sensor and camera processor of the computing device of FIG. 1 in further detail.

FIG. 4 is a conceptual diagram illustrating an example of static flicker detection and correction.

FIG. 5 is a flowchart illustrating a method of operation according to one or more example techniques described in this disclosure.

### DETAILED DESCRIPTION

An image sensor includes a plurality of sensor elements (e.g., photodiodes) that capture light, convert the light to electrical signals, and generate images from the electrical signals. With various filtering techniques, such as including a Bayer filter over the sensor elements, the images may be captured as color images. A user may take a picture using a camera, where the picture is an example of the image.

Some image sensors are configured to generate images using a rolling shutter. With a rolling shutter, the image sensor does not capture the image content of the entire image simultaneously. Instead, the image sensor exposes and captures the image content using a subset of the sensor elements, e.g., row-by-row or column-by-column. Each row or column of the image content may include one or more rows or columns of the sensor elements. For instance, the image sensor may expose a first band of one or more rows or columns of sensor elements, followed by a second band of one or more rows or columns of sensor elements, and so forth. Therefore, the image content of an image frame is captured at different times with rolling shutter.

The capture of image content of the image at different times can lead to flicker or banding, such as where the luminance of the light (i.e., brightness of the light or light intensity) changes during the image capture. For example, the luminance of a lighting source (e.g., fluorescent light or light emitting diode (LED) light) changes periodically based on a period of an alternating current (AC) source used to power the lighting source (e.g., AC from a wall outlet into which the lighting source is connected). As the absolute value of the amplitude of the AC source increases, the luminance of the lighting source increases, and as the absolute value of the amplitude of the AC source decreases, the luminance of the lighting source decreases.

The above describes an example where rolling flicker is caused by rolling shutter. Another type of flicker is static flicker which can be based on exposure time at which images are captured and the rate at which images are captured, measured as frames per second (fps). For instance, the frequency of the AC source may be 50 Hz or 60 Hz based on region. If the exposure time is a multiple of on-half the period of the AC source, there may not be flicker. For example, for a 50 Hz AC source, if the exposure time is a multiple of 10 ms, where 10 ms is one-half of the period of 50 Hz, there may not be flicker. For a 60 Hz AC source, if the exposure time is a multiple of 8.33 ms, where 8.33 ms is one-half of the period of 60 Hz, there may not be flicker. Also, if the capture rate (e.g., fps) is a multiple of the frequency, in combination with the exposure time being a multiple of one-half of the period, there may not be flicker (e.g., if 60 Hz AC source, and the fps is 30 frames-per-second, there may not be flicker). However, higher fps or fps that are not a multiple of the frequency may be desired in difference cases.

In general, the rolling shutter mechanism is one of the primary sources of flicker. This flicker appears to be like flicker bands across the captured image. The nature (e.g., whether rolling flicker bands or static flicker bands), and the intensity and the phase of the flicker bands may be dependent on both exposure time and fps (frames per second).

When exposure time is an integral multiple of one-half the period of the AC source, there may be no flicker bands (e.g., no rolling or static flicker). However, when the exposure time is not an integral multiple of the half period of the AC source, then flicker may occur.

This flicker may be rolling (top to bottom or left to right, etc.) if the frame-time (time between each frame or 1/fps) is not an integral multiple of the AC source's half period. If the frame-time is an integral multiple of the AC source's half period and the exposure time is an integral multiple of the same, then static flicker may occur. In static flicker the flicker bands may not move between frames.

Flicker or banding pattern (e.g., flicker bands) on the images may occur when the exposure time is not an integral multiple of on-half the period of the AC source. This flicker will be rolling flicker if fps is not an integral multiple of the lighting source frequency. This flicker will be static flicker if fps is an integral multiple of the of the lighting source frequency. As described above, flicker may be considered as flicker bands where the luminance varies from band-to-band, where a band in the image corresponds to group of sensor elements (e.g., row or column of sensor elements). In rolling flicker, the location of the flicker bands changes from image to image, and for consecutive images, the flicker bands appear to roll (e.g., move across or move up or down) between the consecutive images. In static flicker, the location of the flicker bands is the same image to image. In other words, a location of the flicker bands in one image having flicker corresponds to a location of the flicker bands in another image.

While both rolling flicker and static flicker degrade image viewer experience, rolling flicker tends to negatively impact user experience compared to static flicker. Accordingly, processing circuitry (e.g., image signal processor) may be configured to control the capture rate so that the exposure time is an integral multiple of the time period of the lighting source. This may reduce or remove rolling flicker, but may produce static flicker. Although static flicker may not negatively impact viewer experience as much as rolling flicker, viewer experience can still be improved by detection and removal of static flicker.

This disclosure describes example techniques for both detecting and reducing flicker. For purpose of illustration and description, the example techniques are described with respect to detecting and reducing static flicker. However, the example techniques are not so limited. In general, because static flicker tends not to change image to image, the detection of static flicker may be challenging.

As described in more detail, the processing circuitry may perturb an initial exposure time that is initially determined as the exposure time at which images should be captured to determine at least one of a first exposure time and a second exposure time. The processing circuitry may cause the image sensor to capture a first image at the first exposure time, and a second image at the second exposure time. More images at different exposure times can also be captured. Therefore, there may be a plurality of images that are each captured at different exposure times.

There may be various characteristics of the flicker. Examples of the characteristic of flicker include a phase of flicker and a strength of the flicker. In some cases, the phase and strength of the flicker may be a function of the exposure time. For instance, the phase and the strength of the flicker in the first image may be different than the phase and strength of the flicker in the second image. The processing circuitry may determine a difference (e.g., pixel-by-pixel subtraction) between the first image and the second image to determine the characteristic of the flicker (e.g., phase and strength of the flicker) if images were captured at the initially determined exposure time. The processing circuitry may then determine a scaling factor to apply to a subsequent image that is captured at the initially determined exposure time to mitigate the effects of the flicker. The scaling factor may be a function of the characteristic of the flicker, such as the strength and phase of the flicker. For instance, the scaling factor may add inverse gain to the image, where the inverse gain is the inverse of the flicker that is added by the periodicity of the lighting source. For example, the scaling factor may reduce the luminance of image content captured when the lighting source was the brightest or increase the luminance of image content captured when the lighting source was the least bright, or both.

By perturbing the exposure time to capture the first and second images, the processing circuitry may ensure that there is sufficient difference in the first and second images for flicker detection and correction. For instance, if the exposure time is kept constant, then the static flicker strength (e.g., how much luminance changes in the flicker bands) and phase (e.g., where the flicker bands are located) in both in the first image and the second image would be the same. In such cases, if the first image and second image are captured consecutively, the image content of the first image and the second image would be the same. Therefore, a difference between the first image and the second image would be negligible, and insufficient for flicker detection.

With the example techniques, the processing circuitry may ensure that the strength and phase of the flicker (e.g., static flicker) is different between images by perturbing the exposure time. As described in more detail, for a given exposure time (e.g., the exposure time at which images are to be captured), the processing circuitry may use the difference in the images to determine the characteristic of flicker (e.g., strength and phase of the flicker) in images captured subsequently. The processing circuitry may then correct for the flicker by determining inverse gain that applies the inverse of the flicker.

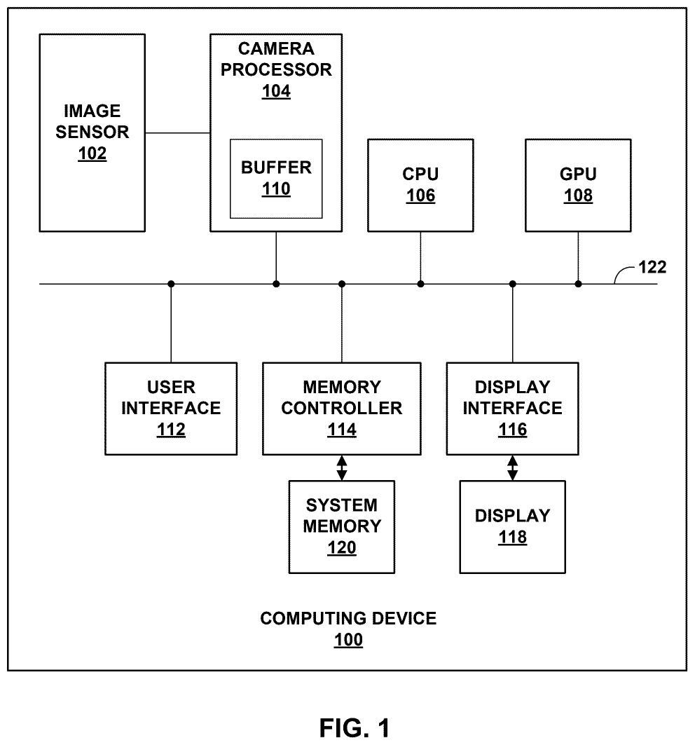

FIG. 1 is a block diagram of a device configured to perform one or more of the example techniques described in this disclosure. Examples of computing device 100 include a computer (e.g., personal computer, a desktop computer, or a laptop computer), a mobile device such as a tablet computer, a wireless communication device (such as, e.g., a mobile telephone, a cellular telephone, a satellite telephone, and/or a mobile telephone handset), a landline telephone for teleconferencing, an Internet telephone, a handheld device such as a portable video game device or a personal digital assistant (PDA). Additional examples of computing device 100 include a personal music player, a video player, a display device, a camera, a television, a set-top box, a broadcast receiver device, a server, an intermediate network device, a mainframe computer or any other type of device that processes and/or displays graphical data.

As illustrated in the example of FIG. 1, computing device 100 includes image sensor 102, a camera processor 104, a central processing unit (CPU) 106, a graphical processing unit (GPU) 108, user interface 112, memory controller 114 that provides access to system memory 120, and display interface 116 that outputs signals that cause graphical data to be displayed on display 118. Camera processor 104 is an example of an image signal processor (ISP).

In FIG. 1, camera processor 104 includes buffer 110. In one or more examples, buffer 110 may be dedicated buffer memory for camera processor 104. That is, buffer 110 may not be available to other components for storage. Buffer 110 need not necessarily be part of camera processor 104. In one or more examples, buffer 110 is a first-in-first-out (FIFO) buffer. As described in more detail, buffer 110 may store images captured with different exposure times that camera processor 104 uses for static flicker detection and correction.

Although FIG. 1 illustrates image sensor 102 as part of the same device that includes camera processor 104, CPU 106, and GPU 108, the techniques described in this disclosure are not so limited. In some examples, camera processor 104, CPU 106, and GPU 108 and many of the various other components illustrated in FIG. 1 may be on a different device (e.g., a processing device) than image sensor 102.

Also, although the various components are illustrated as separate components, in some examples the components may be combined to form a system on chip (SoC). As an example, camera processor 104, CPU 106, GPU 108, and display interface 116 may be formed on a common integrated circuit (IC) chip. In some examples, one or more of camera processor 104, CPU 106, GPU 108, and display interface 116 may be in separate IC chips. Various other permutations and combinations are possible, and the techniques should not be considered limited to the example illustrated in FIG. 1. The various components illustrated in FIG. 1 (whether formed on one device or different devices) may be formed as at least one of fixed-function or programmable circuitry such as in one or more microprocessors, application specific integrated circuits (ASICs), field programmable gate arrays (FPGAs), digital signal processors (DSPs), or other equivalent integrated or discrete logic circuitry.

The various units illustrated in FIG. 1 communicate with each other using bus 122. Bus 122 may be any of a variety of bus structures, such as a third generation bus (e.g., a HyperTransport bus or an InfiniBand bus), a second generation bus (e.g., an Advanced Graphics Port bus, a Peripheral Component Interconnect (PCI) Express bus, or an Advanced extensible Interface (AXI) bus) or another type of bus or device interconnect. It should be noted that the specific configuration of buses and communication interfaces between the different components shown in FIG. 1 is merely exemplary, and other configurations of computing devices and/or other image processing systems with the same or different components may be used to implement the techniques of this disclosure.

Camera processor 104 may be external to computing device 100; however, it may be possible for camera processor 104 to be internal to computing device 100, as illustrated. For instance, in some examples, image sensor 102 and camera processor 104 may form a pluggable camera for a desktop or laptop computer, and CPU 106, GPU 108, and the various other components may be part of the desktop or laptop computer. For case of description, the examples are described with respect to the configuration illustrated in FIG. 1.

Image sensor 102 includes a plurality of sensor elements (e.g., photodiodes) arranged in 2×2 grid. The sensor elements may be CMOS (Complementary Metal-Oxide-Semiconductor) sensor elements. Each sensor element generates an electrical signal based on a luminance of the light incident to the sensor element. With filtering, such as Bayer filtering, the electrical signals generated by each of the sensor element indicate the luminance of a particular color.

Camera processor 104 is configured to receive electrical signals as sensor signals from respective sensor elements of image sensor 102 and process the electrical signals to generate pixel data of an image frame. In some examples, camera processor 104 may be configured as a single-input-multiple-data (SIMD) architecture. Camera processor 104 may perform the same operations on electrical signals received from each of the sensor elements of image sensor 102. Each lane of the SIMD architecture may include an image pipeline. The image pipeline includes hardwire circuitry and/or programmable circuitry (e.g., at least one of fixed-function or programmable circuitry) to process the output of the sensors to generate pixel values for pixels.

In one or more examples, processing circuitry of image sensor 102 may include respective trans-impedance amplifiers (TIAs) to convert the electrical signals (e.g., current) to a voltage and respective analog-to-digital converters (ADCs) that convert the analog voltage output into a digital value. The electrical signal outputted by each sensor element indicates the luminance (e.g., light intensity) of a red, green, or blue component. These examples described with respect to processing circuitry of image sensor 102 may be part of camera processor 104, in some examples.

As described in more detail, in one or more examples, the processing circuitry of image sensor 102, camera processor 104, or possibly some other component may be configured to cause image sensor 102 to capture a plurality of images at different exposure times. Camera processor 104 may utilize the plurality of images to determine characteristics of flicker, such as phase and strength of the flicker. Based on the phase and strength of the flicker, camera processor 104 may determine a scaling factor to apply to image content of a subsequently captured image to correct for the flicker. For instance, the scaling factor may apply a negative of the impact of the flicker to counteract the flicker.

As described above, flicker may be considered as flicker bands where the luminance varies from band-to-band, where a band in the image corresponds to group of sensor elements (e.g., row or column of sensor elements) of sensor 102. In rolling flicker, the location of the flicker bands changes from image to image, and for consecutive images, the flicker bands appear to roll (e.g., move across or move up or down) between the consecutive images. In static flicker, the location of the flicker bands is the same image to image. For example, a location of the flicker bands in one image having flicker corresponds to a location of the flicker bands in another image.

Although static flicker may not negatively impact viewer experience as much as rolling flicker, viewer experience can still be improved by detection and removal of static flicker. This disclosure describes example techniques for both detecting and reducing flicker, and is described with respect to static flicker for purposes of illustration. As described above, static flicker detection may present additional challenges compared to rolling flicker detection due to the flicker bands being in the same location (e.g., corresponding locations) in different images. For case of description, the examples are described with respect to camera processor 104. However, the example techniques are not so limited, and may be performed by other processing circuitry or in combination with processing circuitry of camera processor 104.

In one or more examples, camera processor 104 may be configured to initialize camera parameters such as focus, exposure, and white balance. For instance, camera processor 104 may be configured to perform autofocus, auto-exposure, and auto-white balance routine to determine initial lens location for focus, initial exposure time for image capture, and initial auto-white balance to adjust color.

For instance, for auto-exposure, camera processor 104 may be configured to, with information from image sensor 102, determine the current luminance level, and control the gain level and exposure time to maintain the constant brightness. The ability of camera processor 104 to control the three factors of aperture, sensitivity, and shutter speed is referred to as auto-exposure.

Using the auto-exposure to determine an initial exposure time may be suited well for addressing rolling shutter. However, as described above, static shutter may still be present, such as if the exposure time is not an integral multiple of the time period of the lighting source and frame-to-frame time (1/fps) is an integral multiple of the time period of the lighting source.

There are multiple known techniques for auto-exposure. The examples described in this disclosure are not limited to any particular auto-exposure technique used to determine the initial exposure time.

In one or more examples, camera processor 104 may first perform the auto-exposure operation to determine initial exposure time. Later, camera processor 104 may use this initial exposure time as the exposure time used to capture subsequent images. For instance, device 100 may operate in preview mode or capture mode. In preview mode, camera processor 104 is processing image content for display on display 118, but the image content is not being stored for long term, and only stored for displaying to a viewer. In capture mode, camera processor 104 is capturing pictures for long term storage (e.g., such as a video or a series of images). In preview mode or capture mode, camera processor 104 may cause image sensor 102 to capture images with an exposure time equal to the initial exposure time, or some other determined exposure time if updated.

However, in accordance with one or more examples described in this disclosure, camera processor 104 may first perturb the initial exposure time to determine a plurality of exposure times, and cause image sensor 102 to capture images at the plurality of exposure times (e.g., one image per exposure time, but more than one image is possible). It is also possible that one of the plurality of exposure times is the same as the initial exposure time.

Perturbing the initial exposure time may mean increasing or decreasing, in some cases, very slightly, the initial exposure time. For example, camera processor 104 may add 0.5 ms or subtract 0.5 ms from the initial exposure time, and cause image sensor 102 to capture three images: one at the initial exposure time+0.5 ms, one at the initial exposure time, and one at the initial exposure time-0.5 ms. As another example, camera processor 104 may add 0.5 ms and 1 ms from the initial exposure time, and cause image sensor 102 to capture three images: one at the initial exposure time, one at the initial exposure time+0.5 ms, and one at the initial exposure time+1 ms. Various other examples are possible, including examples in which one of the images is not captured at the initial exposure time.

Camera processor 104 may then determine the characteristic of the flicker (e.g., phase and/or strength of the static flicker), based on these images captured with different exposure times, if a subsequent image is captured at the initial exposure time. The phase of the static flicker may be indicative of locations where flicker bands will be located in the subsequent image. The strength of the static flicker may be indicative of change of luminance of the flicker bands in the subsequent image.

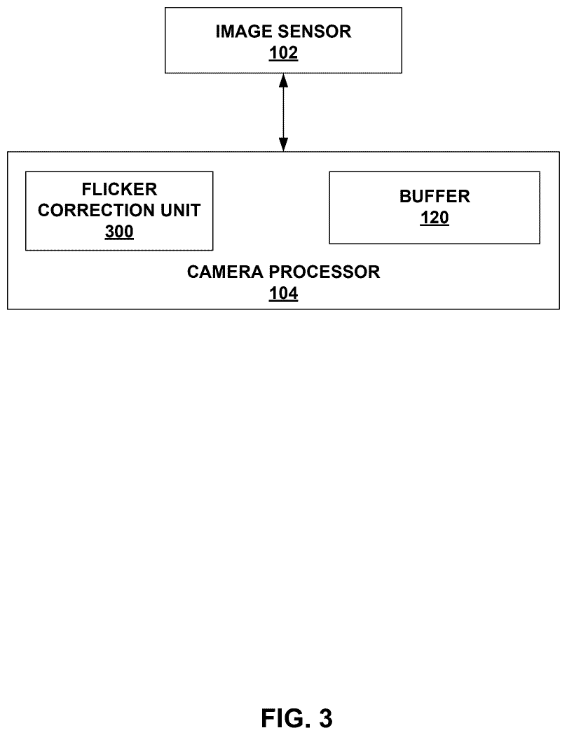

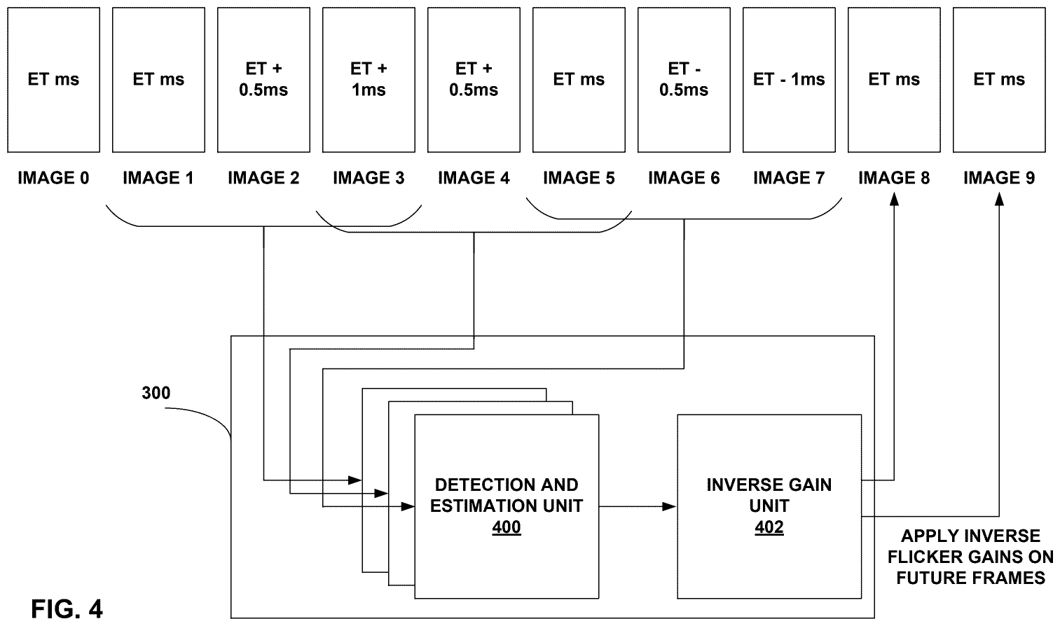

Camera processor 104 may generate an output based on the determined characteristic of flicker. For example, as described in more detail with respect to FIGS. 3 and 4, camera processor 104 may generate a scaling factor to apply to a subsequent image based on the characteristic of flicker. Camera processor 104 may generate a flicker filtered image based on applying the scaling factor to the subsequent image.

Camera processor 104 may then cause the flicker filtered image to be displayed instead of the subsequent image. This way, the image content of the subsequent image is presented to the viewer with reduced flicker (e.g., reduced static flicker), which positively impacts viewer experience.

In some examples, computing device 100 may include a flicker sensor. The flicker sensor may include the capability to sample the intensities (e.g., luminance) at higher frequencies and thus can estimate the phase of the flicker relatively precisely. As described in more detail, in some examples, camera processor 104 may iterate the process of determining characteristic of the flicker on multiple frames. The accurate estimation of phase of the static bands may reduce the requirement to determine characteristic of the flicker multiple times on multiple frames (e.g., reduce perturbation time).

For instance, the flicker sensor sampling rate may be relatively high (e.g., approximately 1000 data points per see). The flicker sensor may sample small region of frame to generate more accurate bands and by using fast Fourier transform (FFT, camera processor 104 may compute the characteristic of the flicker. If sampling or scene region is constant, then FFT can be able to differentiate between scene and flicker frequency.

Furthermore, the techniques described in the disclosure may not be restricted to a single camera or single exposure mode, but may also be used with multiple camera or multi-exposure configurations like high dynamic range (HDR). One such example could be in a simple HDR mode, where two exposures (e.g., short and long exposures) are used to capture images. The short exposure may have an upper limit on the exposure time. When such limit (e.g., of the short exposure) is lower than half-period of AC source, flicker become unavoidable in short frame. Flicker in such cases can be corrected using the example techniques described in this disclosure.

For instance, with the example techniques, short exposure can be filtered with the flicker content and further used in the HDR blend. This can result in a better dynamic range image without flicker. Using a flickered short image in the blend will result in ambiguous output because the difference between flicker-free long and flickered short may be treated as motion despite of just being a simple intensity difference. The HDR modules may be unable to determine whether the difference between the short and long frames is due to flicker or if the difference is due to the local motion. Local motion here refers to the difference in scene content that can happen due to difference in time when both short and long are captured.

Accordingly, in one or more examples, camara processor 104 may perform the example techniques described in this disclosure on the short exposure images to remove the flicker (e.g., generate an output based on the determined characteristic of flicker). The HDR module may then use flicker-corrected short exposure images with the long exposure images for blending to generate the HDR images.

CPU 106 may comprise a general-purpose or a special-purpose processor that controls operation of computing device 100. A user may provide input to computing device 100 to cause CPU 106 to execute one or more software applications. The user may provide input to computing device 100 via one or more input devices (not shown) such as a keyboard, a mouse, a microphone, a touch pad or another input device that is coupled to computing device 100 via user interface 112.

One example of the software application is a camera application. CPU 106 executes the camera application, and in response, the camera application causes CPU 106 to generate content that display 118 outputs. For instance, display 118 may output information such as light intensity, whether flash is enabled, and other such information. The user of computing device 100 may interface with display 118 to configure the manner in which the images are generated (e.g., with or without flash, focus settings, exposure settings, and other parameters). The camera application also causes CPU 106 to instruct camera processor 104 to process the images captured by image sensor 102 in the user-defined manner.

As one example, the user interacting with the camera application may be considered as a start of a camera session, and the end of the camera session may be after the user takes the picture or exits the camera application. In examples where device 100 is a digital camera, the start of the camera session may be when the user turns on the digital camera to take a picture or video.

GPU 108 may generate graphical information that provides the user information about the image frames to be captured. For instance, GPU 108 may generate a graphic that indicates whether flash is enabled, generate boxes around identified faces, etc.

Memory controller 114 facilitates the transfer of data going into and out of system memory 120. For example, memory controller 114 may receive memory read and write commands, and service such commands with respect to memory 120 in order to provide memory services for the components in computing device 100. Memory controller 114 is communicatively coupled to system memory 120. Although memory controller 114 is illustrated in the example of computing device 100 of FIG. 1 as being a processing circuit that is separate from both CPU 106 and system memory 120, in other examples, some or all of the functionality of memory controller 114 may be implemented on one or both of CPU 106 and system memory 120.

System memory 120 may store program modules and/or instructions and/or data that are accessible by camera processor 104, CPU 106, and GPU 108. For example, system memory 120 may store user applications (e.g., instructions for the camera application), resulting images from camera processor 104, etc. System memory 120 may additionally store information for use by and/or generated by other components of computing device 100. For example, system memory 120 may act as a device memory for camera processor 104. System memory 120 may include one or more volatile or non-volatile memories or storage devices, such as, for example, random access memory (RAM), static RAM (SRAM), dynamic RAM (DRAM), read-only memory (ROM), erasable programmable ROM (EPROM), electrically erasable programmable ROM (EEPROM), flash memory, a magnetic data media or an optical storage media.

In some aspects, system memory 120 may include instructions that cause camera processor 104, CPU 106, GPU 108, and display interface 116 to perform the functions ascribed to these components in this disclosure. Accordingly, system memory 120 may be a computer-readable storage medium having instructions stored thereon that, when executed, cause one or more processors (e.g., camera processor 104, CPU 106, GPU 108, and display interface 116) to perform various functions.

In some examples, system memory 120 is a non-transitory storage medium. The term “non-transitory” indicates that the storage medium is not embodied in a carrier wave or a propagated signal. However, the term “non-transitory” should not be interpreted to mean that system memory 120 is non-movable or that its contents are static. As one example, system memory 120 may be removed from computing device 100, and moved to another device. As another example, memory, substantially similar to system memory 120, may be inserted into computing device 100. In certain examples, a non-transitory storage medium may store data that can, over time, change (e.g., in RAM).

Camera processor 104, CPU 106, and GPU 108 may store image data, and the like in respective buffers that are allocated within system memory 120. Display interface 116 may retrieve the data from system memory 120 and configure display 118 to display the image represented by the generated image data. In some examples, display interface 116 may include a digital-to-analog converter (DAC) that is configured to convert the digital values retrieved from system memory 120 into an analog signal consumable by display 118. In other examples, display interface 116 may pass the digital values directly to display 118 for processing.

Display 118 may include a monitor, a television, a projection device, a liquid crystal display (LCD), a plasma display panel, a light emitting diode (LED) array, or another type of display unit. Display 118 may be integrated within computing device 100. For instance, display 118 may be a screen of a mobile telephone handset or a tablet computer. Alternatively, display 118 may be a stand-alone device coupled to computing device 100 via a wired or wireless communications link. For instance, display 118 may be a computer monitor or flat panel display connected to a personal computer via a cable or wireless link.

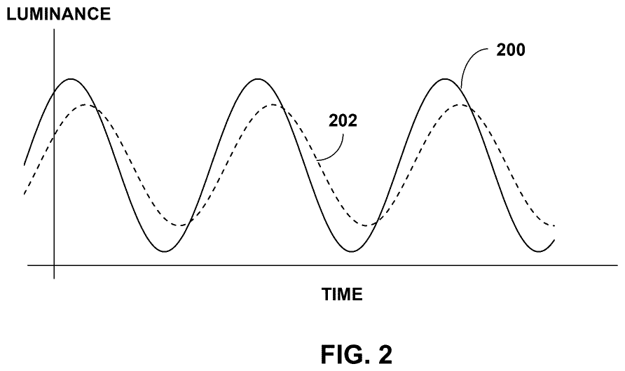

FIG. 2 is a graph illustrating an example of a characteristic of flicker at different exposure times. As described above, camera processor 104 may perturb the exposure time. For instance, camera processor 104 may swing the exposure time values for a few frames (e.g., 4-6 frames which is approximately 150 ms at 30 fps). This will result in change in the characteristic of flicker (e.g., change in the strength and phase of the static flicker bands).

For instance, in FIG. 2, line 200 illustrates the luminance intensity of the flicker bands in an image over time (e.g., over rows or columns of the image) with the exposure time set at 4 ms. Line 202 illustrates the luminance intensity of the flicker bands in an image over time with the exposure time set at 6 ms. In this example, the frequency of the lighting source is 50 Hz.

As can be seen, the strength of the static flicker for the exposure time of 4 ms is greater than the strength of the static flicker for the exposure time of 6 ms. One example way to determine strength of the static flicker is based on the change in luminance (e.g., difference between peak and trough). As can be seen, the peak to trough difference of line 200 with 4 ms exposure time is greater than the peak to trough difference of line 202 with 6 ms exposure time. In this example, with the frequency of lighting source being 50 Hz, as the exposure time approaches 10 ms, which is a multiple of half-period of 50 Hz, the strength of the static flicker decreases. Therefore, the lower the exposure time is, the higher the flicker intensity may be.

Also, the phase of the static flicker for exposure time of 4 ms is different than the phase of the static flicker for exposure time of 6 ms. For instance, the peak of line 200 is at a different time than the peak of line 202, and the trough of line 200 is at a different time than the trough of line 202. In some cases, this may mean that the location of the flicker bands if the exposure time is 6 ms may be different than the location of the flicker bands if the exposure time is 4 ms. Accordingly, change in exposure time may change both phase and amplitude of the static flicker bands.

In one or more examples, camera processor 104 may cause image sensor 102 to capture images at different exposure times. The characteristic of flicker (e.g., phase and strength of the static flicker) may be different in these images, as shown in FIG. 2, since the exposure times are different. Camera processor 104 may be configured to analyze the changes in images with different exposure time, and determine the characteristic of flicker in a subsequent image that is captured at the initial exposure time (or some other exposure time). Camera processor 104 may apply the inverse of the determined flicker gains on to the subsequent image to remove the flicker.

In FIG. 2, the characteristic of flicker is illustrated as the strength and phase of the flicker. However, the strength and phase of the flicker are some examples of the characteristic of flicker, and there may be other examples of the characteristics of flicker.

FIG. 3 is a block diagram illustrating an image sensor and camera processor of the computing device of FIG. 1 in further detail. FIG. 4 is a conceptual diagram illustrating an example of static flicker detection and correction. For ease of description, the example of FIG. 3 and FIG. 4 are described together.

As illustrated in FIG. 3, camera processor 104 includes flicker correction unit 300 and system memory 120. As illustrated in FIG. 4, flicker correction unit 300 includes detection and estimation unit 400 and inverse gain unit 402. Flicker correction unit 300, detection and estimation unit 400, and inverse gain unit 402 may be fixed-function or programmable circuitry configured to perform one or more example techniques described in this disclosure. In this disclosure, the term “processing circuitry” may refer, at least partially, to flicker correction unit 300, including detection and estimation unit 400 and inverse gain unit 402, and/or other circuitry configured to perform the example techniques described in this disclosure in combination with flicker correction unit 300. That is, the processing circuitry may encompass some or all of the circuitry for perform the example techniques described in this disclosure even if such circuitry is distributed across different components.

In the example of FIG. 4, assume that image sensor 102 captured image 0 with an exposure time of ET ms. ET ms may the exposure time that is determined as part of the auto-exposure process, and may be considered as the initial exposure time. In one or more examples, ET ms may be the actual exposure time at which camera processor 104 causes image sensor 102 to capture images.

In accordance with one or more examples described in this disclosure, flicker correction unit 300 may perturb the initial exposure time (ET ms) and capture images with the perturbed exposure time. In one or more examples, the images that captured with the perturbed exposure time may still be displayed to the viewer in preview mode or capture mode, but the example techniques are not so limited. As the example techniques to detect and correct for flicker is performed over a few frames (e.g., 4-6 frames, resulting in about 150 ms of time to detect flicker), even if the images captured with the exposure time are displayed to the viewer, there may be little impact on the viewer experience.

As illustrated in FIG. 4, flicker correction unit 300 may cause image sensor 102 to capture image 1 with an exposure time of ET ms, capture image 2 with an exposure time of ET+0.5 ms, and capture image 3 with an exposure time of ET+1 ms. That is, flicker correction unit 300 may perturb the initial exposure time of ET by 0.5 ms and 1 ms, and capture images with the perturbed exposure time. This is one example, and in other examples, it may be possible that image 1 is captured with an exposure time of ET+0.5 ms, image 2 is captured with an exposure time of ET+1 ms, and image 3 is captured with an exposure time of ET-0.5 ms. Other examples are also possible.

Accordingly, flicker correction unit 300 may cause image sensor 102 to capture a first image of the image data at a first exposure time (e.g., image 1 of FIG. 4), and cause image sensor 102 to capture a second image of the image data at a second exposure time (e.g., image 2 of FIG. 4). Flicker correction unit 300 may also cause image sensor 102 to capture a third image of the image data at a third exposure time (e.g., image 3 of FIG. 4).

In one or more examples, camera processor 104 may determine initial camera parameters including an initial exposure time for capturing images. Flicker correction unit 300 may perturb the initial exposure time to determine at least one of the first exposure time or the second exposure time. For instance, in FIG. 4, flicker correction unit 300 may perturb the initial exposure time by zero ms to determine the first exposure time, but may perturb the initial exposure time by 0.5 ms to determine the second exposure time. Flicker correction unit 300 may perturb the initial exposure time by 1 ms to determine the third exposure time. In some examples, to perturb the initial exposure time, flicker correction unit may be configured to increase or decrease the initial exposure time (e.g., ES) or keep the initial exposure time constant to determine at least one of (e.g., one or both of) the first exposure time and the second exposure time, and in some examples, the third exposure time.

System memory 120 may store image 1, image 2, and image 3 as captured by image sensor 102 at the different exposure times. Detection and estimation unit 400 may then determine a phase of a static flicker or a strength of the static flicker based on at least the first image (e.g., image 1) and the second image (e.g., image 2). As described, the phase of the static flicker may be indicative of locations where flicker bands will be located in a subsequent image, and the strength of the static flicker may be indicative of change of luminance of the flicker bands in the subsequent image.

The following describes example techniques that detection and estimation unit 400 may utilize to determine the phase of the static flicker and/or strength of the static flicker. For instance, detection and estimation unit 400 may determine a difference image based on a difference between the first image (e.g., image 1) and the second image (e.g., image 2). To determine the characteristic of flicker, detection and estimation unit 400 may be configured to determine the characteristic of flicker based on the difference image.

In some examples, the difference between the first image and the second image may be considered as a first difference image. Detection and estimation unit 400 may determine a second difference image based on a difference between the third image (e.g., image 3 of FIG. 4) and the second image (e.g., image 2 of FIG. 4), and determine a third difference image based on a difference between the first image (e.g., image 1 of FIG. 4) and the third image (e.g., image 3 of FIG. 4). To determine the characteristic of flicker, detection and estimation unit 400 may be configured to determine the characteristic of flicker based on the first difference image, the second difference image, and the third difference image.

The following describes the operations that detection and estimation unit 400 may perform to determine the characteristic of flicker.

Consider a light source with temporal illuminance variation as:

$$\begin{matrix}L ( t ) = {A}_{DC} + ( {A}_{AC} {sin}^{2} ( 2 π ft ) ) \\ = {\int }_{{t}_{0}}^{{t}_{0} + {t}_{e}} {A}_{DC} + ( {A}_{AC} {sin}^{2} ( 2 π ft ) )\end{matrix}$$

At constant sensitivity,

$${Img}_{1} = {I}_{0} S [ {A}_{DC} + \frac{{A}_{AC}}{2} - \frac{{A}_{AC}}{4 π f} \frac{sin 2 π {fT}_{e 1}}{{T}_{e 1}} sin ( 4 π {fT}_{0} - 2 π {fT}_{e 1} - 2 Δ {Fid}_{1} ) ]$$

Img₁ refers to the image 1. Iₒ is the image content of the scene, S is the constant that is related to sensitivity, A_{DC} is a DC content of the lighting source, and A_{AC} is the AC content of the light source. The variable f is the lighting source frequency (e.g., 50 Hz or 60 Hz). Tₑ₁ is the exposure time at which Img₁ is captured (e.g., ET ms for FIG. 4 example). T₀ is the start of frame time at which Img₁ is captured. The ΔFid₁ is the very small phase shift that could happen due to not precise capture rate. The ΔFid₁ may be assumed to be zero or negligible, but is included here for example purposes.

It may not be necessary to input in all of the variable values. For instance, it may be possible to determine the value of

$$\frac{{A}_{AC}}{4 π f} \frac{sin 2 π {fT}_{e}}{{T}_{e}} ,$$

without needing to input in the value of A_{AC}.

In this example, Te refers to the exposure time at which subsequent images (e.g., images that are captured after the images that are used to determine static flicker). Also, the value of f, which is the frequency of the lighting source (e.g., 50 Hz or 60 Hz) may be manually input, determined based on some location of device 100 (e.g., different countries use 50 Hz or 60 Hz), or may be determined. For example, as a separate operation to determine “f,” camera processor 104 may set the exposure time to 10 ms and cause image sensor 102 to capture an image to see if there is flicker. If there is flicker, then f is 60 Hz, and if there is no flicker than f is 50 Hz. As another example, as a separate operation to determine “f,” camera processor 104 may set the exposure time to 10 ms and cause image sensor 102 to capture an image, then set the exposure to 8.33 ms and cause image sensor 102 to capture an image. Camera processor 104 may determine the frequency f based on which of these two images has flicker, since the one captured at 10 ms should not have flicker if frequency f is 50 Hz, and the one capture at 8.33 ms should not have flicker if frequency f is 60 Hz.

$$\frac{{A}_{AC}}{4 π f} \frac{sin 2 π {fT}_{e}}{{T}_{e}}$$

may represent the strength of the static flicker, and may be referred to as the flicker ratio. In some examples, the strength of the static flicker may be

$$( \frac{{A}_{AC}}{4 π f} \frac{sin 2 π {fT}_{e}}{{T}_{e}} )$$

divided by (A_{DC}+(A_{AC}/2)). The phase of the static flicker may be 2πfTₑ, and may be indicative of the phase shift with respect to the initial exposure time. Again, Tₑ refers to the exposure time at which subsequent images are captured.

Accordingly, the equation for the first image (e.g., image 1 of FIG. 4 (Img₁)), the equation for the second image (e.g., image 2 of FIG. 4 (Img₂)), and the equation for the third image (e.g., image 3 of FIG. 4 (Img₃)) may be as follows:

$${Img}_{1} = {I}_{0} S [ {A}_{DC} + \frac{{A}_{AC}}{2} - \frac{{A}_{AC}}{4 π f} \frac{sin 2 π {fT}_{e 1}}{{T}_{e 1}} sin ( 4 π {fT}_{0} - 2 π {fT}_{e 1} - 2 Δ {Fid}_{1} ) ]$$

$${Img}_{2} = {I}_{0} S [ {A}_{DC} + \frac{{A}_{AC}}{2} - \frac{{A}_{AC}}{4 π f} \frac{sin 2 π {fT}_{e 2}}{{T}_{e 2}} sin ( 4 π {fT}_{0} - 2 π {fT}_{e 2} - 2 Δ {Fid}_{2} ) ]$$

$${Img}_{3} = {I}_{0} S [ {A}_{DC} + \frac{{A}_{AC}}{2} - \frac{{A}_{AC}}{4 π f} \frac{sin 2 π {fT}_{e 3}}{{T}_{e 3}} sin ( 4 π {fT}_{0} - 2 π {fT}_{e 3} - 2 Δ {Fid}_{3} ) ]$$

Detection and estimation unit 400 may determine differences these images. For example, detection and estimation unit 400 may determine a first difference image (DiffImg1) based on a difference between the second image and the first image. For example, to determine DiffImg1, detection and estimation unit 400 may determine a pixel-by-pixel subtraction of pixel values of pixels in image 1 from pixel values of corresponding pixels of image 2. The equation for DiffImg1 may be:

$$DiffImg 1 = {Img}_{2} - {Img}_{1} = {I}_{0} S \frac{{A}_{AC}}{4 π f} sin ( 4 π {fT}_{0} + α ) {K}_{1} .$$

Detection and estimation unit 400 may determine a second difference image (DiffImg2) based on a difference between the third image and the second image. For example, to determine DiffImg2, detection and estimation unit 400 may determine a pixel-by-pixel subtraction of pixel values of pixels in image 2 from pixel values of corresponding pixels of image 3. The equation for DiffImg2 may be:

$$DiffImg 2 = {Img}_{3} - {Img}_{2} = {I}_{0} S \frac{{A}_{AC}}{4 π f} sin ( 4 π {fT}_{0} + β ) {K}_{2} .$$

Detection and estimation unit 400 may determine a third difference image (DiffImg3) based on a difference between the third image and the second image. For example, to determine DiffImg3, detection and estimation unit 400 may determine a pixel-by-pixel subtraction of pixel values of pixels in image 3 from pixel values of corresponding pixels of image 1. The equation for DiffImg3 may be:

$$DiffImg 3 = {Img}_{1} - {Img}_{3} = {I}_{0} S \frac{{A}_{AC}}{4 π f} sin ( 4 π {fT}_{0} + γ ) {K}_{3} .$$

Using the actual values of DiffImg1, DiffImg2, and DiffImg3, detection and estimation unit 400 may determine the values of α, β, and γ. For instance, detection and estimation unit 400 may determine the values of the values of α, β, and γ using a regression technique, trigonometry equations, or other techniques.

With the values of the values of α, β, and γ, detection and correction unit 400 may determine the values for

$$\frac{{A}_{AC}}{4 π f} \frac{sin 2 π {fT}_{e}}{{T}_{e}}$$

and 2πfTₑ+2ΔFid. The value of 2ΔFid may be negligible. That is, detection and estimation unit 400 may determine the strength of the static flicker for any given exposure time

$$( e . g . , \frac{{A}_{AC}}{4 π f} \frac{sin 2 π {fT}_{e}}{{T}_{e}} or ( \frac{{A}_{AC}}{4 π f} \frac{sin 2 π {fT}_{e}}{{T}_{e}} )$$

divided by (A_{DC}+ (A_{AC}/2)), and determine the phase of the static flicker for any given exposure time (e.g., 2πfTₑ+2ΔFi).

Inverse gain unit 402 may be configured to apply inverse flicker gains on subsequent images. That is, inverse gain unit 402 may generate an output based on the determined one or more of the phase of the static flicker and the strength of the static flicker (e.g., based on the determined characteristic of flicker). As an example, inverse gain unit 402 may generate a scaling factor to apply to the subsequent image based on the characteristic of flicker, and generate a flicker filtered image based on applying the scaling factor to the subsequent image. For example, image 8 in FIG. 4 may be a flicker filtered image.

The following is an example of the equation for the scaling factor:

$$\frac{1}{1 + ( \frac{\frac{{A}_{AC}}{4 π f} \frac{sin 2 π {fT}_{e}}{{T}_{e}}}{{A}_{DC} + \frac{{A}_{AC}}{2}} ) sin ( x - ( 2 π {fT}_{e} + 2 Δ Fid ) )}$$

For example, to generate a flicker filtered image based on applying the scaling factor to the subsequent image, inverse gain unit 402 may perform the following:

$$Flicker filtered image = subsequent image * ( \frac{1}{1 + ( \frac{\frac{{A}_{AC}}{4 π f} \frac{sin 2 π {fT}_{e}}{{T}_{e}}}{{A}_{DC} + \frac{{A}_{AC}}{2}} ) sin ( x - ( 2 π {fT}_{e} + 2 Δ Fid ) )} )$$

That is, inverse gain unit 402 may apply the inverse of the flicker gain to the subsequent image. The result may be an image with reduced flicker (e.g., reduced static flicker).

In the example illustrated in FIG. 4, detection and estimation unit 400 receives images 1, 2, and 3, as well as images 3, 4, and 5, and images 5, 6, and 7 for purposes of flicker detection and estimation of flicker parameters such as phase of the flicker and the strength of the flicker. In some examples, it may be sufficient to detect flicker and estimate flicker parameters using only images 1, 2, and 3. However, there may be benefits for detection and estimation unit 400 to detect flicker and estimate flicker parameters two or three times to mitigate wrong estimations.

For example, in some examples, detection and estimation unit 400 may determine flicker parameters such as phase of the static flicker and the strength of the static flicker using images 1, 2, and 3. Then, detection and estimation unit 400 may determine flicker parameters such as phase of the static flicker and the strength of the static flicker using images 3, 4, and 5, where image 4 is captured with exposure time of ET+0.5 ms, and image 5 is captured with exposure time of ET. Then, detection and estimation unit 400 may determine flicker parameters such as phase of the static flicker and the strength of the static flicker using images 5, 6, and 7, where image 6 is captured with exposure time of ET-0.5 ms, and image 7 is captured with exposure time of ET-1 ms. Detection and estimation unit 400 may average, weighted average, or some other technique to determine the phase of the static flicker and the strength of the static flicker, which may less likely suffer from a wrong estimation than if only images 1, 2, and 3 were used.

Furthermore, there may be benefit in detection and estimation unit 400 periodically updating the phase of the static flicker and the strength of the static flicker. For instance, camera processor 104 may periodically perturb the initial exposure time to generate varying exposure times, and cause the image sensor 102 to capture additional images at the varying exposure times. Camera processor 104 may periodically update the characteristic of flicker based on at least the additional images.

For example, the subsequent picture (e.g., image 8) is a first subsequent picture. Camera processor 104 may cause image sensor 102 to capture additional images at varying exposure times (e.g., images 10, 11, and 12, or even later images (not shown in FIG. 4)). Detection and estimation unit 400 may periodically update the characteristic of flicker (e.g., periodically determine updated phase of the flicker or updated strength of the flicker) based on at least the additional images. For example, as described, camera processor 104 may periodically perturb the initial exposure time to generate varying exposure times. Camera processor 104 may cause the image sensor 102 to capture additional images at the varying exposure times, and periodically update the characteristic of flicker based on at least the additional images.

The updated phase of the flicker may be indicative of locations where flicker bands will be located in a second subsequent image (e.g., image 25), and the updated strength of the static flicker may be indicative of change of luminance of the flicker bands in the second subsequent image. In some examples, camera processor 104 may repeat such example operations every 20 seconds to every minute to update the characteristic of flicker (e.g., update the phase and strength of the flicker). However, the frequency at which the phase and strength of the static flicker are updated may be different. In some examples, updating the phase and strength of the static flicker is not necessary and not performed.

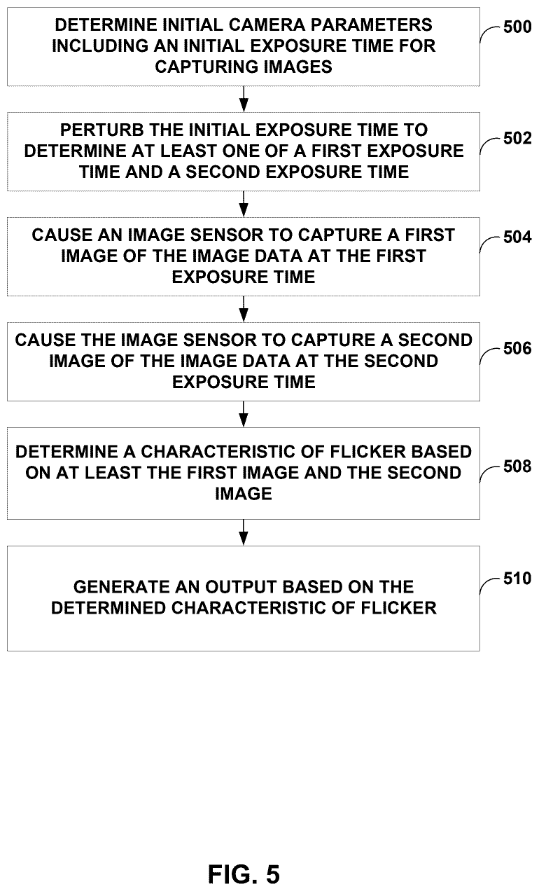

FIG. 5 is a flowchart illustrating a method of operation according to one or more example techniques described in this disclosure. For case of example, the techniques of FIG. 5 are described with respect to processing circuitry, such as processing circuitry of camera processor 104. For instance, the processing circuitry of camera processor 104 may be coupled to one or more memories (e.g., system memory 120) that are configured to store image data (e.g., the images captured at different exposure times).

Processing circuitry (e.g., of camera processor 104) may be configured to determine initial camera parameters including an initial exposure time for capturing images (500). As described above, there may be various ways to determine the initial exposure time, such as part of auto-exposure process. The techniques are not limited to a particular manner in which to determine the initial exposure time. Also, the determining of initial camera parameters may include determining the initial exposure time, without necessarily determining other camera parameters.

The processing circuitry (e.g., such as via flicker correction unit 300) may be configured to perturb the initial exposure time to determine at least one of a first exposure time and a second exposure time (502). For example, to perturb the initial exposure time, flicker correction unit 300 may be configured to increase or decrease the initial exposure time to determine at least one of the first exposure time and the second exposure time. In some examples, the first exposure time or the second exposure time the same as the initial exposure time.

The processing circuitry may cause image sensor 102 to capture a first image of the image data at the first exposure time (504), and cause image sensor 102 to capture a second image of the image data at the second exposure time (506). The first image may be image 1 of FIG. 4, and the second image may be image 2 of FIG. 4.

As described, in static flicker, the flicker bands may be located in same location in multiple images (e.g., two different images) captured at the same exposure time (e.g., unlike rolling flicker). For example, the characteristic of flicker includes flicker bands, and a location of the flicker bands in one image having flicker corresponds to a location of the flicker bands in another image. In some examples, the processing circuitry of camera processor 104 may be configured to output, for display (e.g., on display 118), the first image and the second image as part of preview mode or capture mode.

The processing circuitry may be configured to determine a characteristic of flicker based on at least the first image and the second image (508). For instance, a phase of a static flicker or a strength of the static flicker based on at least the first image and the second image. For example, the characteristic of flicker includes a phase of the flicker or a strength of the flicker. The phase of the flicker may be indicative of locations where flicker bands will be located in a subsequent image. The strength of the flicker may be indicative of change of luminance of the flicker bands in the subsequent image.

As one example, the processing circuitry may determine a difference image based on a difference between the first image and the second image (e.g., DiffImg1 described above). To determine the characteristic of flicker, the processing circuitry may be configured to determine the characteristic of flicker based on the difference image. For instance, the difference image may be a first difference image (e.g., DiffImg1). The processing circuitry may cause the image sensor 102 to capture a third image of the image data at a third exposure time (e.g., Image 3 of FIG. 4). The processing circuitry may determine a second difference image based on a difference between the third image and the second image (e.g., DiffImg2 described above), and determine a third difference image based on a difference between the first image and the third image (e.g., DiffImg3 described above).

To determine the characteristic of the flicker, the processing circuitry may be configured to determine the characteristic of flicker based on the first difference image, the second difference image, and the third difference image. For instance, the processing circuitry may determine the values of α, β, and γ, as described above, and based on the values of α, β, and γ, the processing circuitry may determine the values for

$$\frac{{A}_{AC}}{4 π f} \frac{sin 2 π {fT}_{e}}{{T}_{e}} and 2 π {fT}_{e} + 2 Δ Fid .$$

The strength of the static flicker may be represented by

$$\frac{{A}_{AC}}{4 π f} \frac{sin 2 π {fT}_{e}}{{T}_{e}} ,$$

such as

$$( ( \frac{{A}_{AC}}{4 π f} \frac{sin 2 π {fT}_{e}}{{T}_{e}} )$$

divided by (A_{DC}+ (A_{AC}/2))), and the phase of the static flicker may be 2πfTₑ+2ΔFid, for a given value of Tₑ which is the exposure time. That is, if the subsequent image is to be captured with the initial exposure time, or possibly some updated exposure time, of ET, then Tₑ would equation ET.

The processing circuitry may generate an output based on the determined characteristic of flicker (510). For example, the processing circuitry may generate a scaling factor to apply to the subsequent image based on the characteristic of the flicker (e.g., at least one of the phase of the static flicker and the strength of the static flicker). One example of the scaling factor is:

$$\frac{1}{1 + ( \frac{\frac{{A}_{AC}}{4 π f} \frac{sin 2 π {fT}_{e}}{{T}_{e}}}{{A}_{DC} + \frac{{A}_{AC}}{2}} ) sin ( x - ( 2 π {fT}_{e} + 2 Δ Fid ) )} .$$

The processing circuitry may generate a flicker filtered image based on applying the scaling factor to the subsequent image. For example, the processing circuitry may perform the following to generate the flicker filtered image:

$$Flicker filtered image = subsequent image * ( \frac{1}{1 + ( \frac{\frac{{A}_{AC}}{4 π f} \frac{sin 2 π {fT}_{e}}{{T}_{e}}}{{A}_{DC} + \frac{{A}_{AC}}{2}} ) sin ( x - ( 2 π {fT}_{e} + 2 Δ Fid ) )} )$$

The following describes one or more examples in accordance with the techniques described in this disclosure.

Clause 1. A device for image processing, the device comprising: one or more memories configured to store image data; and processing circuitry coupled to the one or more memories, wherein the processing circuitry is configured to: determine initial camera parameters including an initial exposure time for capturing images; perturb the initial exposure time to determine at least one of a first exposure time and a second exposure time; cause an image sensor to capture a first image of the image data at the first exposure time; cause the image sensor to capture a second image of the image data at the second exposure time; determine a characteristic of flicker based on at least the first image and the second image; and generate an output based on the determined characteristic of flicker.

Clause 2. The device of clause 1, wherein the characteristic of flicker includes a phase of the flicker or a strength of the flicker, wherein the phase of the flicker is indicative of locations where flicker bands will be located in a subsequent image, and the strength of the flicker is indicative of change of luminance of the flicker bands in the subsequent image.

Clause 3. The device of any of clauses 1 and 2, wherein to perturb the initial exposure time, the processing circuitry is configured to increase or decrease the initial exposure time to determine at least one of the first exposure time and the second exposure time.

Clause 4. The device of any of clauses 1-3, wherein to generate the output, the processing circuitry is configured to: generate a scaling factor to apply to a subsequent image based on the characteristic of flicker; and generate a flicker filtered image based on applying the scaling factor to the subsequent image.

Clause 5. The device of any of clauses 1-4, wherein the processing circuitry is configured to: determine a difference image based on a difference between the first image and the second image, wherein to determine the characteristic of flicker, the processing circuitry is configured to determine the characteristic of flicker based on the difference image.

Clause 6. The device of clause 5, wherein the difference image comprises a first difference image, wherein the processing circuitry is configured to: cause the image sensor to capture a third image of the image data at a third exposure time; determine a second difference image based on a difference between the third image and the second image; and determine a third difference image based on a difference between the first image and the third image, wherein to determine the characteristic of flicker, the processing circuitry is configured to determine the characteristic of flicker based on the first difference image, the second difference image, and the third difference image.

Clause 7. The device of any of clauses 1-6, wherein the processing circuitry is configured to: periodically perturb the initial exposure time to generate varying exposure times; cause the image sensor to capture additional images at the varying exposure times; and periodically update the characteristic of flicker based on at least the additional images.

Clause 8. The device of any of clauses 1-7, wherein the characteristic of flicker includes flicker bands, wherein a location of the flicker bands in one image having flicker corresponds to a location of the flicker bands in another image.

Clause 9. The device of any of clauses 1-8, wherein the processing circuitry is configured to output, for display, the first image and the second image as part of preview mode or capture mode.

Clause 10. The device of any of clauses 1-9, wherein the device comprises one of a camera, a mobile telephone, and a tablet computer.

Clause 11. A method of image processing, the method comprising: determining initial camera parameters including an initial exposure time for capturing images; perturbing the initial exposure time to determine at least one of a first exposure time and a second exposure time; causing an image sensor to capture a first image of image data at the first exposure time; causing the image sensor to capture a second image of the image data at the second exposure time; determining a characteristic of flicker based on at least the first image and the second image; and generating an output based on the determined characteristic of flicker.

Clause 12. The method of clause 11, wherein the characteristic of flicker includes a phase of the flicker or a strength of the flicker, wherein the phase of the flicker is indicative of locations where flicker bands will be located in a subsequent image, and the strength of the flicker is indicative of change of luminance of the flicker bands in the subsequent image.

Clause 13. The method of any of clauses 11 and 12, wherein perturbing the initial exposure time comprising increasing or decreasing the initial exposure time to determine at least one of the first exposure time and the second exposure time.

Clause 14. The method of any of clauses 11-13, wherein generating the output comprises: generating a scaling factor to apply to a subsequent image based on the characteristic of flicker; and generating a flicker filtered image based on applying the scaling factor to the subsequent image.

Clause 15. The method of any of clauses 11-14, further comprising: determining a difference image based on a difference between the first image and the second image, wherein determining the characteristic of flicker comprises determining the characteristic of flicker based on the difference image.

Clause 16. The method of clause 15, wherein the difference image comprises a first difference image, the method further comprising: causing the image sensor to capture a third image of the image data at a third exposure time; determining a second difference image based on a difference between the third image and the second image; and determining a third difference image based on a difference between the first image and the third image, wherein determining the characteristic of flicker comprises determining the characteristic of flicker based on the first difference image, the second difference image, and the third difference image.

Clause 17. The method of any of clauses 11-16, further comprising: causing the image sensor to capture additional images at varying exposure times; and periodically updating the characteristic of flicker based on at least the additional images.

Clause 18. The method of any of clauses 11-17, wherein the characteristic of flicker includes flicker bands, wherein a location of the flicker bands in one image having flicker corresponds to a location of the flicker bands in another image.

Clause 19. The method of any of clauses 11-18, further comprising outputting, for display, the first image and the second image as part of preview mode or capture mode.

Clause 20. One or more computer-readable storage media storing instructions thereon that when executed cause one or more processors to: determine initial camera parameters including an initial exposure time for capturing images; perturb the initial exposure time to determine at least one of a first exposure time and a second exposure time; cause an image sensor to capture a first image of image data at the first exposure time; cause the image sensor to capture a second image of the image data at the second exposure time; determine a characteristic of flicker based on at least the first image and the second image; and generate an output based on the determined characteristic of flicker.

Clause 21. The computer-readable storage media of clause 20 further comprising instructions that cause the one or more processors to perform the method of any of clauses 12-19.

Clause 22. A device comprises means for performing the method of any of clauses 11-19.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media. In this manner, computer-readable media generally may correspond to tangible computer-readable storage media which is non-transitory. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. It should be understood that computer-readable storage media and data storage media do not include carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A device for image processing, the device comprising:
one or more memories configured to store image data; and
processing circuitry coupled to the one or more memories, wherein the processing circuitry is configured to:
determine initial camera parameters including an initial exposure time for capturing images;
perturb the initial exposure time to determine at least one of a first exposure time and a second exposure time;
cause an image sensor to capture a first image of the image data at the first exposure time;
cause the image sensor to capture a second image of the image data at the second exposure time;
determine a characteristic of flicker based on at least the first image and the second image; and
generate an output based on the determined characteristic of flicker.

2. The device of claim 1, wherein the characteristic of flicker includes a phase of the flicker or a strength of the flicker, wherein the phase of the flicker is indicative of locations where flicker bands will be located in a subsequent image, and the strength of the flicker is indicative of change of luminance of the flicker bands in the subsequent image.

3. The device of claim 1, wherein to perturb the initial exposure time, the processing circuitry is configured to increase or decrease the initial exposure time to determine at least one of the first exposure time and the second exposure time.

4. The device of claim 1, wherein to generate the output, the processing circuitry is configured to:
generate a scaling factor to apply to a subsequent image based on the characteristic of flicker; and
generate a flicker filtered image based on applying the scaling factor to the subsequent image.

5. The device of claim 1, wherein the processing circuitry is configured to:
determine a difference image based on a difference between the first image and the second image,
wherein to determine the characteristic of flicker, the processing circuitry is configured to determine the characteristic of flicker based on the difference image.

6. The device of claim 5, wherein the difference image comprises a first difference image, wherein the processing circuitry is configured to:
cause the image sensor to capture a third image of the image data at a third exposure time;
determine a second difference image based on a difference between the third image and the second image; and
determine a third difference image based on a difference between the first image and the third image,
wherein to determine the characteristic of flicker, the processing circuitry is configured to determine the characteristic of flicker based on the first difference image, the second difference image, and the third difference image.

7. The device of claim 1, wherein the processing circuitry is configured to:
periodically perturb the initial exposure time to generate varying exposure times;
cause the image sensor to capture additional images at the varying exposure times; and
periodically update the characteristic of flicker based on at least the additional images.

8. The device of claim 1, wherein the characteristic of flicker includes flicker bands, wherein a location of the flicker bands in one image having flicker corresponds to a location of the flicker bands in another image.

9. The device of claim 1, wherein the processing circuitry is configured to output, for display, the first image and the second image as part of preview mode or capture mode.

10. The device of claim 1, wherein the device comprises one of a camera, a mobile telephone, and a tablet computer.

11. A method of image processing, the method comprising:
determining initial camera parameters including an initial exposure time for capturing images;
perturbing the initial exposure time to determine at least one of a first exposure time and a second exposure time;
causing an image sensor to capture a first image of image data at the first exposure time;
causing the image sensor to capture a second image of the image data at the second exposure time;
determining a characteristic of flicker based on at least the first image and the second image; and
generating an output based on the determined characteristic of flicker.

12. The method of claim 11, wherein the characteristic of flicker includes a phase of the flicker or a strength of the flicker, wherein the phase of the flicker is indicative of locations where flicker bands will be located in a subsequent image, and the strength of the flicker is indicative of change of luminance of the flicker bands in the subsequent image.

13. The method of claim 11, wherein perturbing the initial exposure time comprising increasing or decreasing the initial exposure time to determine at least one of the first exposure time and the second exposure time.

14. The method of claim 11, wherein generating the output comprises:
generating a scaling factor to apply to a subsequent image based on the characteristic of flicker; and
generating a flicker filtered image based on applying the scaling factor to the subsequent image.

15. The method of claim 11, further comprising:
determining a difference image based on a difference between the first image and the second image,
wherein determining the characteristic of flicker comprises determining the characteristic of flicker based on the difference image.

16. The method of claim 15, wherein the difference image comprises a first difference image, the method further comprising:
causing the image sensor to capture a third image of the image data at a third exposure time;
determining a second difference image based on a difference between the third image and the second image; and
determining a third difference image based on a difference between the first image and the third image,
wherein determining the characteristic of flicker comprises determining the characteristic of flicker based on the first difference image, the second difference image, and the third difference image.

17. The method of claim 11, further comprising:
causing the image sensor to capture additional images at varying exposure times; and
periodically updating the characteristic of flicker based on at least the additional images.

18. The method of claim 11, wherein the characteristic of flicker includes flicker bands, wherein a location of the flicker bands in one image having flicker corresponds to a location of the flicker bands in another image.

19. The method of claim 11, further comprising outputting, for display, the first image and the second image as part of preview mode or capture mode.

20. One or more computer-readable storage media storing instructions thereon that when executed cause one or more processors to:
determine initial camera parameters including an initial exposure time for capturing images;
perturb the initial exposure time to determine at least one of a first exposure time and a second exposure time;
cause an image sensor to capture a first image of image data at the first exposure time;
cause the image sensor to capture a second image of the image data at the second exposure time;
determine a characteristic of flicker based on at least the first image and the second image; and
generate an output based on the determined characteristic of flicker.
